(19) United States
(12) Patent Application Publication
(10) Pub. No.: US 2005/0251915 A1
(43) Pub. Date: Nov. 17, 2005

(54) System for raising and lowering the upper platform of a bed

(76) Inventor: Adan Elizondo, Garza Garcia (MX)

Correspondence Address: John A. Thomas, 2200 One Galleria Tower, 13355 Noel Road, L.B. 48, Dallas, TX, 75240-1518, US

(21) Appl. No.: 10/936,919

(22) Filed: Sep. 8, 2004

(30) Foreign Application Priority Data
May 13, 2004 (MX) PA/A/2004/004535

(51) Int. Cl. A61G 7/012

(52) U.S. Cl. 5/611; 5/616

(57) ABSTRACT

A collapsible structure for beds comprises a lower frame; the frame having a floor. There is at least one front and at least one rear transverse support and at least one longitudinal support supported by the floor. At least two front arms are pivotally attached to the front transverse support and joined so as to pivot together. At least two rear arms are pivotally attached to the rear transverse support. Upper support arms are pivotally connected between the front and rear arms, for supporting a platform. A linear actuator is connected between the front arms and the rear transverse support for raising and lowering the collapsible structure; finally there is provided a means for adjusting the height of the structure in its raised position. In one embodiment, the linear actuator is an electromechanical actuator.

### CLAIM FOR PRIORITY

This application claims the priority of Mexican Patent Application serial number PA/a/2004/004535, titled “Sistema de Levantamiento y Abatimiento de Plataforma Superior de Soporte de Colchón Para Camas.”

### FIELD OF THE INVENTION

This disclosure is related to an improvement for beds, specifically to a system for raising and lowering the upper platform of a bed which supports a mattress, and a mechanism for adjusting a mattress on a bed that allows the upper platform to be raised and moved with respect to a lower platform.

### BACKGROUND

In the field of design and building of beds for sleeping, significant advances have been made, especially in hospital beds or beds for the ill or people with physical limitations, which makes them more easily accessible, more comfortable and allows for easy and simple maneuverability. In some cases, advances have allowed for varying the sleeping position. That is to say, they are designed to be operated automatically to allow for placing the platform in different positions with different angles of inclination, and also at different heights. The majority of these beds require complex structures and electric mechanisms that make possible the maneuverability and multiple positions of the sleeping platforms.

In existing beds, the structure typically does not allow for graduation of strength or velocity in its activation, nor it does it have a mechanism which stops the platform from being raised higher than its top position, thus making a toppling of the sleeping platform possible.

There is also a risk with such beds that once the platform is in the desired position, the platform is pushed downward but in the opposite direction of the head of the bed, thus causing an excessive displacement of the sleeping platform from its base and the resultant loss of the center of gravity and possible toppling-over. Such beds typically do not have a mechanism that maintains the sleeping platform in a working position, thus avoiding its accidental return to the resting position.

Existing beds typically have four collapsible metallic elements on the ends of the sides which, when changed from the working position to the resting position, scrape against the lower metallic structure turning these collapsible metallic elements into guillotines that can be quite dangerous for the person who is using the bed. Also the arrangement is inconvenient, since the bed sheets can easily be caught between the supports and the side structure.

Thus a system for raising and lowering an upper platform on which the mattress is supported, which on the one hand allows for raising the platform on which the mattress rests (or the adjusting mechanism for a mattress) from a collapsed resting position to an elevated working position and which allows for fast, easy and efficient return of the platform on which the mattress rests to a collapsed resting position, would resolve the above mentioned inconveniences, provide more operating advantages and maneuverability, and would be highly advantageous over existing structures.

### SUMMARY

A collapsible structure for beds comprises a lower frame; the frame having a floor. There is at least one front and at least one rear transverse support and at least one longitudinal support supported by the floor. At least two front arms are pivotally attached to the front transverse support and joined so as to pivot together. At least two rear arms are pivotally attached to the rear transverse support. Upper support arms are pivotally connected between the front and rear arms, for supporting a platform.

A linear actuator is connected between the front arms and the rear transverse support for raising and lowering the collapsible structure; finally there is provided a means for adjusting the height of the structure in its raised position. In one embodiment, the linear actuator is an electromechanical actuator.

In another embodiment where the linear actuator is pneumatic, there is a means for hooking and holding the two front arms to the longitudinal support so as to hold the structure in its raised position, and a means for releasing the two front arms from the longitudinal support.

### DRAWINGS

FIG. 1 shows a perspective view of the structure for a bed with the raising and collapsing system for an upper platform that supports a mattress or an adjusting mechanism for bed mattresses, in on of its preferred embodiments.

FIG. 2 shows a perspective view of the extreme position of the linear actuator, showing its attachment.

FIG. 3 shows a perspective view of the structure for a bed with the raising and collapsing system for an upper platform that supports a mattress, or an adjusting mechanism for bed mattresses, in another of its preferred embodiments.

FIG. 4 shows a cross section of the structure for a bed with the raising and collapsing system for an upper platform that supports a mattress, shown in FIG. 3.

FIG. 5 shows a top view of the structure for a bed with the raising and collapsing system for an upper platform of a bed, as shown in FIGS. 3 and 4.

### DETAILED DESCRIPTION

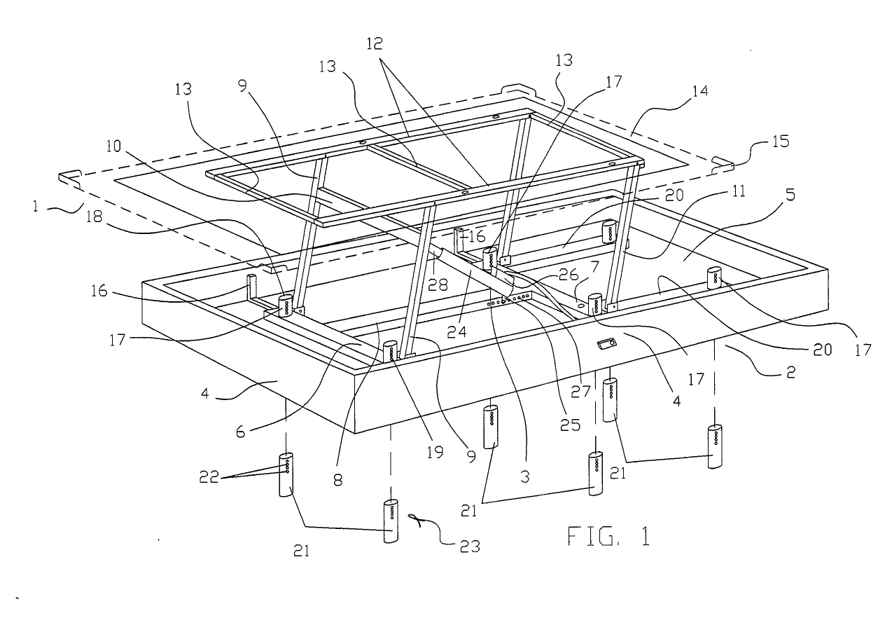

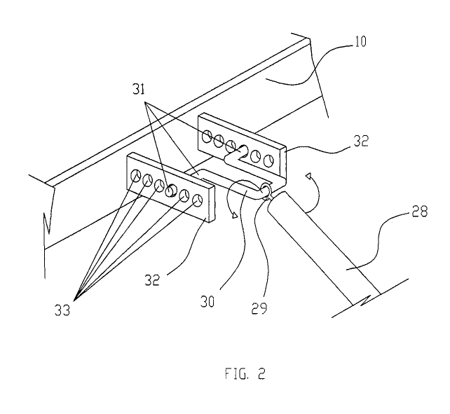

FIGS. 1 and 2 show the structure for a bed that comprises an upper collapsible platform 1 together with a lower platform 2, and a raising and lowering system 3 between the two. The lower platform 2 comprises a frame 4 with perimeter walls and a lower floor 5. It is made up of a front transverse support 6 and a rear transverse support 7, joined by a central longitudinal affixing support 8.

The upper collapsible platform 1 comprises a pair of front collapsible arms 9 with a transverse arm 10 which connects the pair on the top. There is a pair of rear collapsible arms 11, the pairs joined with articulation on the lower end to the front transverse support 6 and to the rear transverse support 7, respectively; and on the upper end joined to a pair of lateral support arms 12. The lateral support arms 12 may be joined with several transverse reinforcing supports 13 to give more strength to the upper platform 1. Upper platform 1 comprises a support assembly 14 that has corners 15 that hold the mattress.

The first and second front transverse supports (6 and 7) can also include extreme lateral extensions 16 attached to the inside of the side walls of the lower platform 2, to support and give body to the side walls.

In addition, the lower platform 2 comprises various cylinders, or tubes, 17 with top end cover 18 and a series of holes 19, distributed at specific points and preferably at least two on the first and two on the front and rear transverse supports (6 and 7), and located in front of the pivotal joining points of the collapsible front 9 and rear 11 arms. The cylinders 17 pass through the supports to the front face of the floor 5, and at least two cylinders 17 with the same characteristics, pass through the floor 5 near the head end of the bed and through extensions 20. The function of the extensions 20 is to provide direct support to the pair of upper side support arms 12 which hold up the upper platform 1 in the resting position. Cylindrical legs 21 have transverse holes 22 placed diametrically opposite which allow for the insertion of pins 23 in the corresponding holes of the cylinders 17 to adjust and regulate the desired height and raise even more the lower platform 2 if need be.

The raising and lowering system 3 for the upper platform 1 preferably comprises at least one linear actuator 24 with a base 25 on which the actuator is placed, and with which on its lower end it is affixed to the rear transverse support 7 near the central longitudinal mounting support 8. The rear transverse support 7 has several aligned holes 27 with an insertion means (not shown) to affix the linear actuator 24 through its base 25 in multiple positions as required. The actuator 24 is preferably a linear electromechanical actuator, but may be a hydraulic or pneumatic actuator.

The linear electromechanical actuator 24 consists on its upper end of a protruding end 28, an eye or hook fastening means 29 which holds by means of a rigid U-shaped revolving support 30 on its two arms 31 a pair of support projections 32 dependent on the transverse arm 10 that joins the front pair of collapsible arms 9 on the top. The support projections 32 consist of various aligned holes 33 in which may be inserted the arms 31 of the rigid U-shaped revolving support 30 to regulate the raising or the upper platform 1.

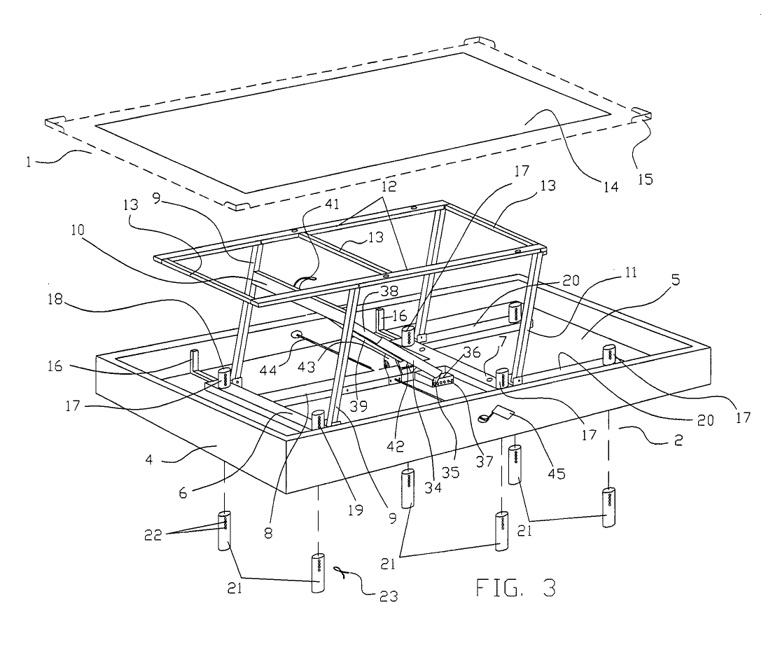

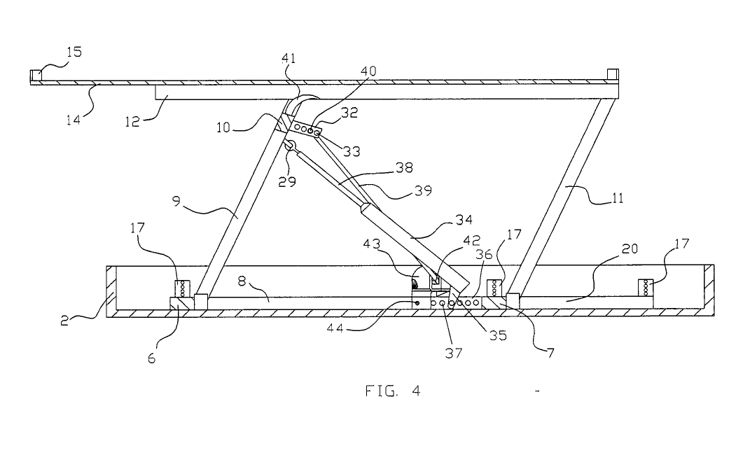

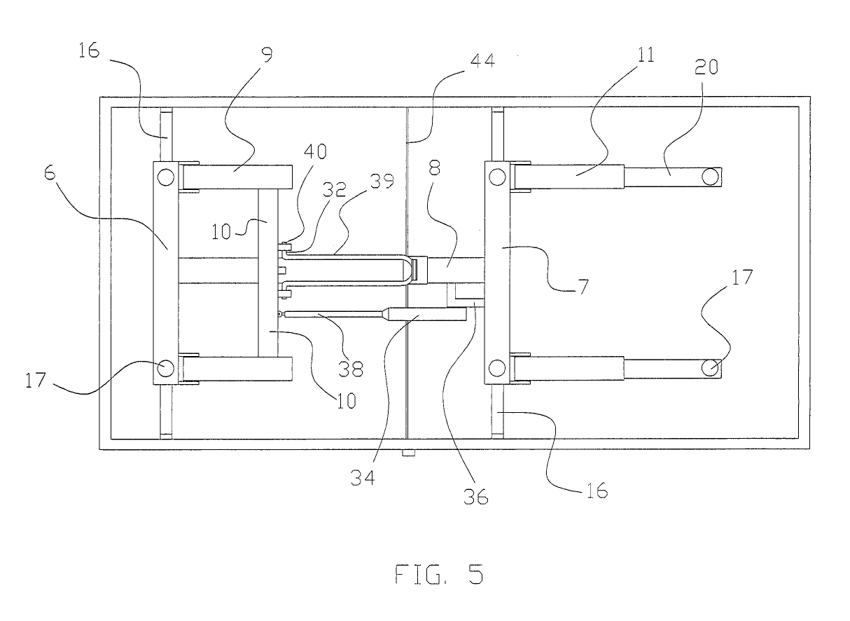

FIGS. 3, 4 and 5 show another embodiment of the system that includes at least one pneumatic actuator 34 with its base 35 affixed on a perpendicular lateral projection 36 of the central longitudinal mounting support 8, next to the rear transverse support 7. The rear transverse support 7 has several aligned holes 37 with an insertion means (not shown) for affixing the linear pneumatic actuator 34 through its the base 35 in multiple positions, as required. The linear pneumatic actuator 34 comprises on its upper end of its drive rod 38 a fastening eye or hook 29 that is revolvingly attached at a point to the transverse arm 10 that joins the pair of front collapsible arms 9 at the top.

Not having a motor to prevent return of the structure to a resting position, this embodiment therefore requires a rigid tension arm 39, preferably U-shaped, so that the closed part of the rigid tension arm 39 engages the holding and hooking means 42 on the central longitudinal mounting support 8. On its open end the rigid tension arm 39 comprises perpendicular extensions with hooks 40 for affixing to a pair of depending support projections 32 of the transverse arm 10 that joins the pair of front collapsible arms 9 on the top. These depending support projections 32 comprise various aligned holes 33 into which the arms of the U-shaped tension arm 39 are placed, to regulate the height for raising the upper platform 1 and maintaining it in its working position.

In addition, for the correct functioning of the system for raising and collapsing and to hold up the upper platform 1 in its resting position, a connecting hook 41 is placed on the transverse arm 10 that joins the front pair of collapsible arms 9 on top, so as to engage the hooking and holding means 42 placed on the central longitudinal mounting support 8.

The releasing means in its preferred embodiment comprises a latch release 43, activated by means of a shaft 44, placed transversely across the bottom frame 4, which is has a switch pedal 45 that is outside the side walls of the lower platform 2. The pedal 45 may have an extension that may be placed near the headboard to prevent its being an obstacle. Upon activating the switch pedal 45, shaft 44 rotates, and the latch means 43 releases the connecting hook 41, thus permitting the horizontal and vertical movement of, and thus the raising of, the upper platform 1.

The latch release 43 for releasing the holding and hooking means 42, in another of the preferred embodiments, may be an electromechanical mechanism, such as a solenoid or magnetic catch, that operates when a switch is activated on the outside of the lower frame or by remote control, thus opening and closing the hooking and holding means 42.

The invention has been sufficiently described so that a person skilled in the art may reproduce and obtain the results I have mentioned in the present disclosure. However, if any person skilled in the art of the technique involved in the present invention, makes modifications not described in the present application but makes use of the material claimed herein for the application of these modifications in the determined structure or the method for manufacturing the same, the structures fall within the broad scope and ambit of the invention as is herein set forth.

1. A collapsible structure for beds, the structure comprising:
a lower frame; the frame having a floor;
at least one front and at least one rear transverse support and at least one longitudinal support supported by the floor;
at least two front arms; the front arms pivotally attached to the front transverse support and joined so as to pivot together;
at least two rear arms; the rear arms pivotally attached to the rear transverse support;
upper support arms pivotally connected between the front and rear arms, for supporting a platform;
a linear actuator connected between the front arms and the rear transverse support for raising and lowering the collapsible structure; and,
a means for adjusting the height of the structure in its raised position.

2. The collapsible structure for beds of claim 1, where the linear actuator is an electromechanical actuator.

3. A collapsible structure for beds, the structure comprising:
a lower frame; the frame having a floor;
at least one front and at least one rear transverse support and at least one longitudinal support supported by the floor;
at least two front arms; the front arms pivotally attached to the front transverse support and joined so as to pivot together;
at least two rear arms; the rear arms pivotally attached to the rear transverse support;
upper support arms pivotally connected between the front and rear arms, for supporting a platform;
a linear actuator connected between the front arms and the rear transverse support for raising and lowering the collapsible structure;
a means for hooking and holding the two front arms to the longitudinal support so as to hold the structure in its raised position, and a means for releasing the two front arms from the longitudinal support; and,
a means for adjusting the height of the structure in its raised position.

4. The collapsible structure for beds of claim 3, where the linear actuator is a pneumatic actuator.

5. The collapsible structure for beds of claim 3, where the means for hooking and holding the two front arms to the longitudinal support comprises a latch.

6. The collapsible structure for beds of claim 5, where the means for hooking and holding the two front arms to the longitudinal support further comprises a rigid tension arm.

8. The collapsible structure for beds of claim 3 where means for releasing comprises a pedal outside the frame operatively connected to open the latch.

9. The collapsible structure for beds of claim 3 where the means for adjusting the height of the structure in its raised position comprises:
a rigid tension arm, the rigid tension arm having an open end and a closed end;
the open end of the rigid tension arm pivotally connected to the front arms; and,
the longitudinal support supporting a latch for receiving the closed end of the rigid tension arm and holding it against the downward force of the raised structure.

10. The collapsible structure for beds of claim 9 where the place of connection of the rigid tension arm to the front arms is adjustable.

11. A collapsible structure for beds, the structure comprising:
a lower frame; the frame having a floor;
at least one front and at least one rear transverse support and at least one longitudinal support supported by the floor;
at least two front arms; the front arms pivotally attached to the front transverse support and joined so as to pivot together;
at least two rear arms; the rear arms pivotally attached to the rear transverse support;
upper support arms pivotally connected between the front and rear arms, for supporting a platform;
a means for holding the two front arms to the longitudinal support to hold the structure in its raised position, and a means for releasing the two front arms from the longitudinal support; and,
a means for adjusting the height of the structure in its raised position.

12. A collapsible structure for beds, the structure comprising:
a lower frame; the frame having a floor;
at least one front and at least one rear transverse support and at least one longitudinal support supported by the floor;
at least two front arms; the front arms pivotally attached to the front transverse support and joined so as to pivot together;
at least two rear arms; the rear arms pivotally attached to the rear transverse support;
upper support arms pivotally connected between the front and rear arms, for supporting a platform;
a linear actuator connected between the front arms and the rear transverse support, and;
a means for releasing the two front arms from the longitudinal support.

13. A collapsible structure for beds, the structure comprising:
a lower frame; the frame having a floor;
at least one front and at least one rear transverse support and at least one longitudinal support supported by the floor,
at least two front arms; the front arms pivotally attached to the front transverse support and joined so as to pivot together;
at least two rear arms; the rear arms pivotally attached to the rear transverse support;
upper support arms pivotally connected between the front and rear arms, for supporting a platform;
a pneumatic actuator connected between the front arms and the rear transverse support;
a latch for holding the two front arms to the longitudinal support so as to hold the structure in its raised position, and a pedal outside the frame operatively connected to the latch for releasing the two front arms from the longitudinal support;
a means for adjusting the height of the structure in its raised position, the means for adjusting comprising:
a rigid tension arm, the rigid tension arm having an open end and a closed end;
the open end of the rigid tension arm pivotally connected to the front arms; and,
the longitudinal support supporting a latch for receiving the closed end of the rigid tension arm and holding it against the downward force of the raised structure,
where the place of connection of the rigid tension arm to the first front arms is adjustable; and,
adjustable legs connected to the lower platform.
